(19) United States
(12) Patent Application Publication
(10) Pub. No.: US 2005/0217371 A1
(43) Pub. Date: Oct. 6, 2005

(54) Acceleration and displacement sensor

(76) Inventors: Leao Wang, Taiping (TW); Peter Wu, Taiping (TW)

Correspondence Address: KUO-HSIUNG CHIU, 13F., NO.23, JIUN-HO STREET, PEITUN DISTRICT, TAICHUNG, 406, TW

(21) Appl. No.: 10/813,245

(22) Filed: Mar. 31, 2004

(51) Int. Cl. G01P 15/00

(52) U.S. Cl. 73/488

(57) ABSTRACT

The invention relates to an acceleration and displacement sensor having a position signal generator, a signal-detecting and arithmetic unit, a power supper unit and a rolling ball. The position signal generator forms a closed space for defining the movement path of the rolling ball. The position signal generator includes a plurality of sensing terminals aligned to one another in axial direction. Each sensing terminal represents a certain position signal value. The position signal value of the sensing terminal, where the rolling ball is located, will be continuously given to the signal-detecting and arithmetic unit. When the rolling ball is forced to move in axial direction, the signal-detecting and arithmetic unit can calculate different position signal values and obtain their change during a certain time period, thereby determining the displacement distance and the acceleration value.

### BACKGROUND OF THE INVENTION

1. Fields of the Invention

The invention relates to an acceleration and displacement sensor, and more particularly, to an apparatus utilizing a rolling ball in interaction with sensing terminals for determing displacement valve and for calculating acceleration value.

2. Description of the Related Art

A displacement sensor, as shown in FIG. 5, includes a sensing coil 60 interacting with a cone 70. The cone 70 moves within the sensing coil 60 for producing the change of inductance frequency which can be converted to the displacement value in micron or even nanometer by means of a signal amplifier 61, a phase-shift circuit 62, a frequency deviation sensor 63 and a displacement calculator 64. The signal amplifier 61, the phase-shift circuit 62, the frequency deviation sensor 63 and the displacement calculator 64 are normally integrated in a microprocessor.

In the above-mentioned disclosure, it is claimed that the sensing coil 60 can eliminate interference caused by the coil magnetic field through a certain arrangement. Theoretically to say, the interference is possibly overcome. However, many factors, like coil specification, material purity, current intensity, current stability, the preciseness of the coil arrangement, the connection of the apparatus, etc. can produce magnetic interference. Therefore, we are much skeptical about this solution with respect to the detection preciseness and stability.

### SUMMARY OF THE INVENTION

In light of the demerits of the prior art, the invention provides an acceleration and displacement sensor that aims to ameliorate at least some of the disadvantages of the prior art and to provide a useful alternative.

A primary objective of the invention is to provide an acceleration and displacement sensor utilizing a rolling ball in interaction with sensing terminals for determing the displacement valve and for calculating the acceleration value.

### BRIEF DESCRIPTION OF THE DRAWINGS

The accomplishment of this and other objects of the invention will become apparent from the following description and its accompanying drawings of which:

FIG. 1 is a schematic drawing of a first embodiment of the invention;

FIG. 2 is a schematic drawing of a second embodiment of the invention;

FIG. 3 is a schematic drawing of a third embodiment of the invention;

FIG. 4 is a cutaway view of FIG. 3; and

FIG. 5 is a schematic drawing of a conventional displacement sensor.

### DETAILED DESCRIPTION OF THE PREFERRED EMBODIMENT

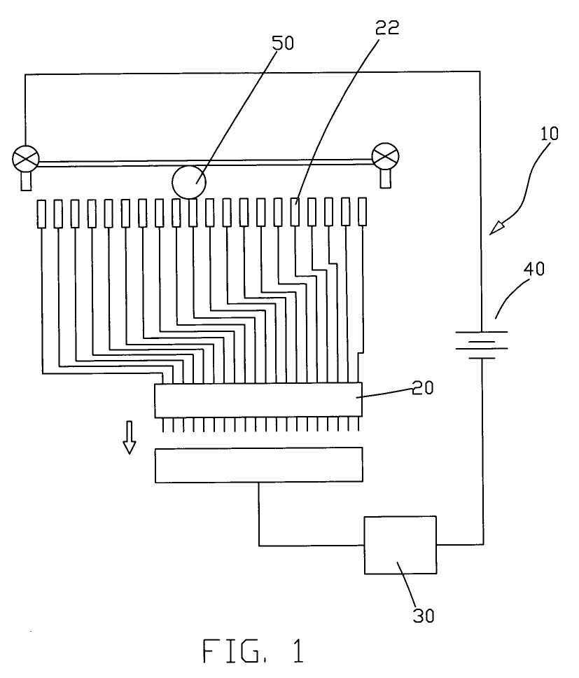

Referring to FIG. 1, the acceleration and displacement sensor in accordance with the invention includes a position signal generator 20, a signal-detecting and arithmetic unit 30, a power supper unit 40 and a rolling ball 50. The position signal generator 20 forms a closed space for defining the movement path of the rolling ball 50.

The position signal generator 20 includes a plurality of sensing terminals 22 aligned to one another in axial direction. Each sensing terminal 22 represents a certain position signal value. The position signal value of the sensing terminal 22, where the rolling ball 50 is located, will be continuously given to the signal-detecting and arithmetic unit 30. When the rolling ball 50 is forced to move in axial direction, the signal-detecting and arithmetic unit 30 can calculate different position signal values and obtain their change during a certain time period, thereby determining the displacement distance and the acceleration value.

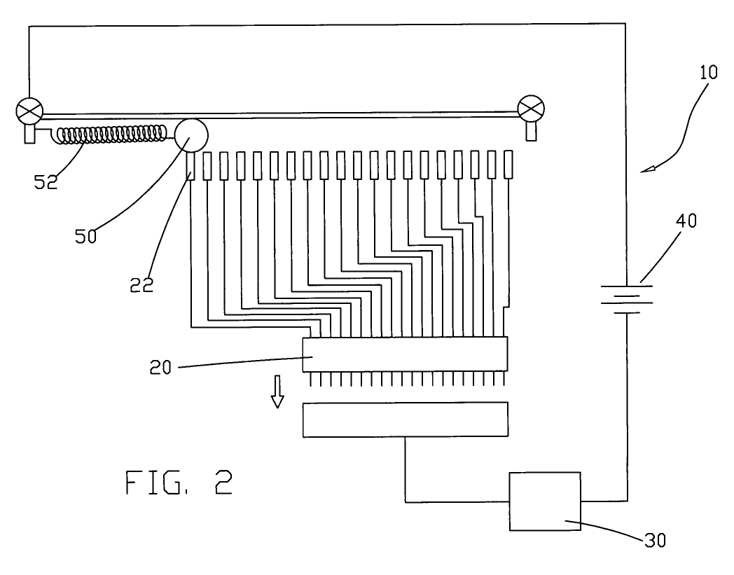

As shown in FIG. 2, an expansion spring 52 is attached to the rolling ball 50. The rolling ball 50 is movable by an external force while it, after being released, returns to its original position whose signal value is null.

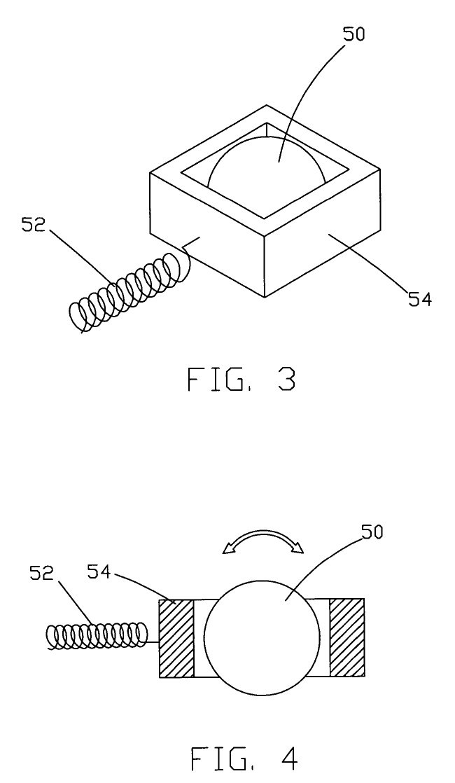

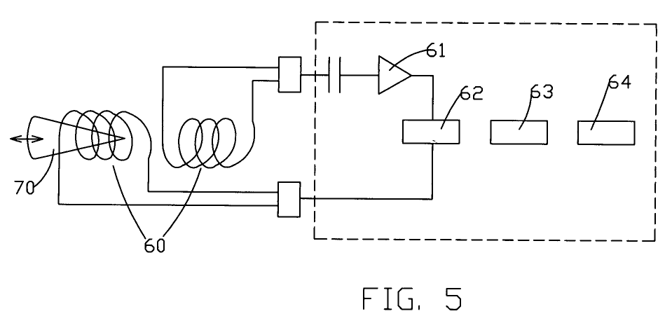

In order to reduce the frictional force between the rolling ball 50 and the sensing terminals 22 and to protect from deviation of the operational value caused by the frictional force, the rolling ball 50, as shown in FIGS. 3 and 4, can be movably received in a frame 54.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

1. An acceleration and displacement sensor comprising:
a) a position signal generator having a plurality of sensing terminals aligned to one another in axial direction, the sensing terminal each representing a certain position signal value;
b) a rolling ball movable within a closed space defined by the position signal generator;
c) a signal-detecting and arithmetic unit for receiving and calculating the position signal value of the sensing terminal where the rolling ball is located; and
d) a power supper unit connected to the signal-detecting and arithmetic unit, whereby, when the rolling ball is forced to move in axial direction, the signal-detecting and arithmetic unit can calculate different position signal values and obtain their change during a certain time period, thereby determining the displacement distance and the acceleration value.

2. The acceleration and displacement sensor of claim 1 further comprising an expansion spring attached to the rolling ball so that the rolling ball is movable by an external force while it, after being released, returns to its original position whose signal value is null.

3. The acceleration and displacement sensor of claim 1 further comprising a frame around the rolling ball so that the rolling ball is movably received within the frame.
